(19) United States
(12) Patent Application Publication
(10) Pub. No.: US 2002/0016847 A1
(43) Pub. Date: Feb. 7, 2002

(54) Method for testing of students at a remote testing facility

(76) Inventor: Stephen M. Soldis, Santa Rosa, CA (US)

Correspondence Address: Thomas E. Smith, Lee, Mann, Smith, McWilliams, Sweeney & Ohlson, P.O. Box 2786, Chicago, IL, 60690-2786, US

(21) Appl. No.: 09/919,165

(22) Filed: Jul. 31, 2001

Related U.S. Application Data
(60) Provisional application No. 60/221,747, filed on Jul. 31, 2000.

(51) Int. Cl. G06F 15/16; G06F 11/30; G06F 12/14; H04L 9/00

(52) U.S. Cl. 709/229; 713/200; 709/218

(57) ABSTRACT

Disclosed is a method of providing a verified test of a student by a test provider at a testing facility remote from the test provider. The method provides the student with a recognizable student identification indicia and the testing facility with a recognizable verification indicia indicative of verification of the student's identity by the facility. Both indicia are required to be entered on a computer terminal at the test facility enabling the student to proceed with the taking of the test at the interactive web site of the test provider, and the test provider is thus assured that the person taking the test is in fact the person who should be taking the test. The process is particularly adapted to providing a traffic school test required by a court.

This application is a non-provisional application and claims priority of provisional application No. 60/221,747 filed Jul. 31, 2000.

### BACKGROUND OF THE INVENTION

This invention relates to a method of testing online, at a remote testing facility, students who have completed a distance learning home study program, and more particularly, to a testing method which would permit the testing of students whose identities have been verified at remote testing facilities. The invention has particularly application to traffic school/driver improvement courses provided over the Internet and the testing of students taking those courses. Accordingly the invention will be described in connection with an online course provided by a traffic school, although it will be recognized that the invention will be applicable to other types of distance learning and testing by other types of educational institutions or certification programs.

There have been previous efforts to provide traffic school/driver improvement courses over the Internet (global information computer network). However, when it comes to the testing of those students, it has been necessary to rely upon the assumption that the student identity is that which has been represented on-line by the student. The present invention is a process by means of which the student identity can be verified and the test provider can be assured of the proper identity of the student taking the test. There have been suggestions for voice recognition technology which would require the student to register his voice at the beginning of the course and then call in at certain times during the course. However, at best this only proves that the student calling in at the appointed time was in fact the student who had registered for the course, but there was nothing to prevent someone else from taking the test for that student. Other proposals have been to verify the student identity by asking personal questions that pop up during the course. However, since these are simply the same questions that the student answered during the registration process, this is an easy system for cheating. Moreover, if the questions are matters which are private to the student, serious privacy concerns may arise.

The present invention permits the student to register for and take an educational course on-line using any computer that is connected to the global information computer network, i.e., the Internet. However, the student would be required to take the course final exam at an approved testing facility where the identity of the student can be verified. The final exam would be completed on-line but could only be accessed by an employee of the testing facility by entering a unique password.

In accordance with one embodiment of the invention, the method of verifying student identity by a course provider at a test facility remote from the course provider includes: providing each student with a recognizable identification indicia; providing the testing facility with a recognizable student identity verification indicia which may be changed periodically; the entry by the student into an on-line computer at the testing facility of the student's identification indicia; the verification of the student's identification by the testing facility; the entry by the testing facility into the on-line computer of the testing facility's student identity verification indicia; and thereafter providing an on-line test for the student and receiving answers to the test from the student, whereby the test provider may test the student and be assured of the proper identity of the student being tested.

It is contemplated that the testing would take place at facilities which are easily accessible to the student and near the student's home or work location and which have that may be used by the students to access on the Internet the home page of the course/test provider. As used herein, the term “student” is meant to encompass any individual who is seeking qualification by virtue of a written examination, usually after completing a course of study or other learning experience.

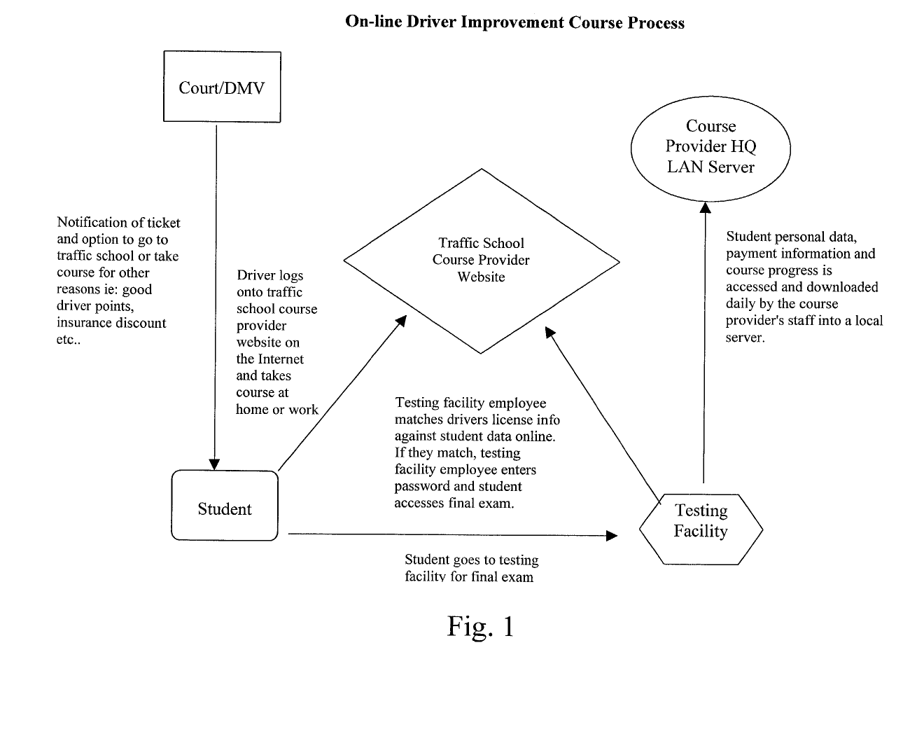

A flow chart of the process for a driver improvement course, such as an interactive Internet traffic school, is illustrated FIG. 1.

The process at the testing facility may be as follows:

1. The student accesses the website of the course provider and logs into the course. The student is informed that he will be able to take the course at home, but he will be required to go to one of the participating testing centers for the final exam. A list of the participating testing centers is provided online with interactive maps. It is contemplated that there would be a time limit for the final examination and would normally be included in the school's tuition.

2. After the student completes the course at home, for example, he proceeds to a participating testing center and identifies himself as a student of the school (course provider). The testing center employees are already trained how to process the students, but they also have an instruction card from the school which explains everything they need to know. The student is then assigned to a computer at the testing center. The testing center employee opens a web browser and accesses the school's website.

3. Once at the school's website, the student logs into his course using his login name which has been given to him by the school and then clicks on the button that says, for example, “I'm at the testing center and ready to take my final examination.” This opens a screen which asks the testing center employee to verify the identity of the student who will be taking the test. This may, for example be a verification that the photo on the license presented on line by the school matches the person who is present at the testing facility, and/or a verification that the student's name and driver's license number on the screen matches the information on the driver's license presented to the testing facility by the student wishing to take the test. If they match, the testing center employee enters a unique (frequently changed) password which consists of proprietary indicia given by the school to the testing center. Such student verification indicia is preferably a combination of codes to further maintain the integrity of the system and prevent easy dissemination of the password to unauthorized persons. This gives the student access to his final exam which he can then complete. If the information does not match, the employee will not allow access to the final exam.

4. Once the student completes his exam he or she is prompted to print out a confirmation page which contains his completion data and a notice to the testing center cashier whether or not payment is needed according to the agreement between the school and the testing facility. (If the student spends over the allotted time, or if this is a subsequent visit by the student, the student may be notified that he or she may have to pay for the additional computer time). Usually payment is required from the student before proceeding with the study program although in some instances the payment may be taken by the testing facility at the time of testing.

5. The student's information is date-stamped on school's server. The date, time, location and online time of his testing center visit is all recorded. This information can be used by school for quality assurance and may also be subject to audit by the overseeing government body and by the testing center. Additionally, an automated accounting system may be used which posts the student names and the testing center visit data on a secure page where the testing center can download the data directly into their accounting system. The school then transmits a monthly payment to the testing center/corporate headquarters based on a per visit basis.

6. If any technical problems are encountered at the testing facility, the employee at the testing facility may provide the student with a backup paper exam as described below.

Back-Up Testing Process to On-line Testing Process at the Testing Facility

1. Students of course provider (such as a traffic school students) will identify themselves with their driver's license or other form of identification acceptable to the school.

2. Testing facility employee will provide the exam to the student.

3. The student will complete the student information requested on the last page of the exam (“student name”, “student login #”, “date”).

4. Testing facility employee will initial on the “testing facility employee” line on the last page of the exam to confirm that the driver's license matches the student's name on the exam.

5. The student will complete the exam within the testing facility.

6. The student will present the completed exam to the testing facility employee.

7. Testing facility employee will fax the completed exam to the course provider.

A. Course Provider's Responsibilities for Back Up Exam

1. The course provider will provide a hard copy of the back up exam to testing facility for purposes of distribution to testing facility stores in accordance with the terms set forth herein and will provide testing facility with revised exams each time they are revised by the course provider. The course provider will be solely responsible for the content and version of the exam provided to the testing facility.

2. The course provider will be responsible for grading student exams after submission from a testing facility employee.

B. Testing Facility Responsibilities for Back Up Exam

1. Testing facility employees will verify the student's identification as described above and will initial on the “testing facility employee” line on the last page of the back up exam to confirm that the driver's license matches the student's name on the exam.

2. Testing facility store employees will collect the back up exam from the student and submit the exam to the course provider as set forth above.

The foregoing description has been given only by way of example. Many different types of courses other than traffic school courses may be provided and students tested utilizing the invention. However, the process is particularly adapted to traffic school courses in which there may be enrolled a wide variety of students with different degrees of education and with different work schedules, for which this process provides a great deal of flexibility and is therefore particularly well adapted. The process could be adapted to certification or licensing programs where an examination is part of the certifying or qualification process. Such certification programs could be certification could be of lawyers, doctors, engineers, appraisers, and so forth. As will be readily apparent to one skilled in the art many modifications of the process may be made without departing from the spirit and scope of the invention as hereinafter claimed.

I claim:

1. A method of providing for the verified testing of a student by a test provider at a testing facility remote from said test provider, said method comprising:
providing said student with a recognizable student identification indicia;
providing the testing facility with a recognizable verification indicia indicative of verification by the testing facility of the identification of said student;
accessing on the internet through a terminal at said testing facility a predetermined interactive web site for said test provider;
transmitting to said predetermined interactive web site through said terminal at said testing facility of both the student identification indicia and said verification indicia; and
providing on said predetermined interactive web site a test for the student and receiving answers to that test from the student,
whereby the test provider may test the student and be assured of the proper identification of the student being tested.

2. The method of claim 1 wherein the student identification indicia is transmitted to said predetermined interactive web site through said terminal at said testing facility prior to the transmission of said verification indicia by said testing facility.

3. The method of claim 1 wherein said verification indicia is a password provided to the testing facility to be entered by the testing facility after it has verified the identity of the student taking the test.

4. The method of claim 3 wherein said password system is periodically changed by said test provider to maintain the integrity of the system.

5. The method of claim 4 wherein said password is a combination of codes to further maintain the integrity of the system and prevent dissemination of the password to unauthorized persons.
